(19) United States
(12) Patent Application Publication
(10) Pub. No.: US 2014/0300984 A1
(43) Pub. Date: Oct. 9, 2014

(54) CIRCUITS AND METHODS FOR CANCELLING A REFLECTED WAVE

(71) Applicant: TEXAS INSTRUMENTS INCORPORATED, Dallas, TX (US)

(72) Inventors: Rajarshi Mukhopadhyay, Allen, TX (US); Matthew D. Rowley, Parker, TX (US)

(73) Assignee: Texas Instruments Incorporated, Dallas, TX (US)

(21) Appl. No.: 13/859,617

(22) Filed: Apr. 9, 2013

(51) Int. Cl. G11B 5/09

(52) U.S. Cl. CPC G11B 5/09
USPC 360/46; 327/551

(57) ABSTRACT

Method and circuits for cancelling reflected waves from a load are disclosed. An embodiment of the method includes transmitting a signal to the bad from a current source, wherein a transistor is connected in parallel with the current source at a node. The transistor is biased so that a reflected wave at the node will cause the drain to source voltage of the transistor to increase. The drain current of the first transistor increases by way of channel length modulation when the drain to source voltage increases, the increased drain current cancels the reflected wave.

### BACKGROUND

Several high-speed data systems are subject to inherent impedance mismatches leading to reflections during data transmission. Because data is being transmitted at high speeds, the reflected waves present problems that are different than with analog signals. For example, the reflected waves may interfere with the transmitted data and cause errors.

One area where high speed data signals are transmitted is to magnetic heads on hard disk drives. As the data transfer rates of the disk drives become faster, the transmitter and receiver circuits of preamplifiers driving the magnetic heads are subject to reflections. With very high data rates, a reflected signal may interfere with a subsequently transmitted signal, which can cause errors and limit the bandwidth and data capacity of the disk drive.

### SUMMARY

Method and circuits for cancelling reflected waves from a load are disclose. An embodiment of the method includes transmitting a signal to the load from a current source, wherein a transistor is connected in parallel with the current source at a node. The transistor is biased so that a reflected wave at the node will cause the drain to source voltage of the transistor to increase. The drain current of the first transistor increases by way of channel length modulation when the drain to source voltage increases, the increased drain current cancels the reflected wave.

### BRIEF DESCRIPTION OF THE DRAWINGS

FIG. 1 is a schematic illustration of a circuit for transmitting data to and from a head of a disk drive.

FIG. 2A is a graph showing signals and reflected waves associated with the first current source of FIG. 1 in a first operative mode.

FIG. 2B is a graph showing signals and reflected waves associated with the second current source of FIG. 1 in the first operative mode.

FIG. 3 is a graph showing the relationships between drain current and the drain to source voltage of the transistors described above.

FIG. 4A is a graph showing signals and reflected waves associated with the first current source of FIG. 1 in a second operative mode.

FIG. 4B is a graph showing signals and reflected waves associated with the second current source of FIG. 1 in the second operative mode.

### DETAILED DESCRIPTION

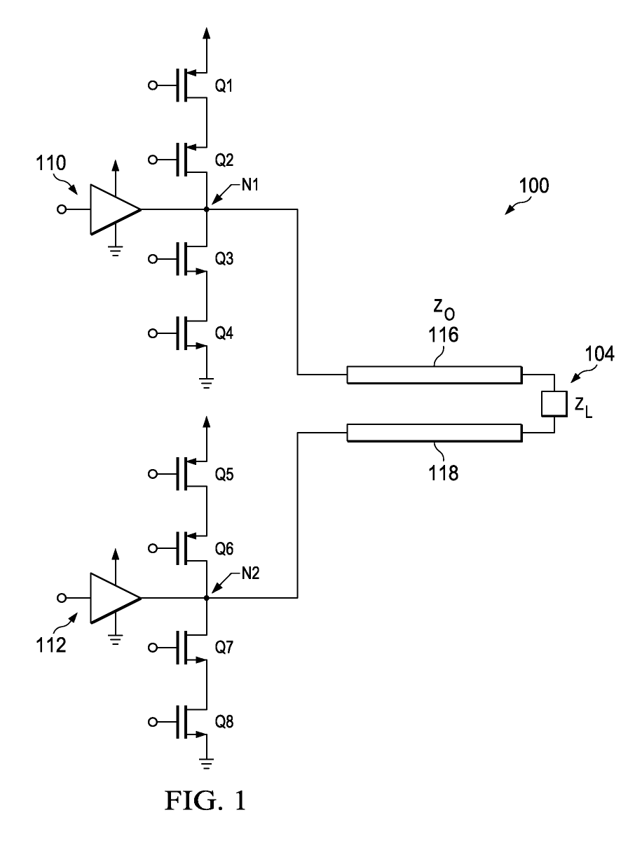

An embodiment of a circuit 100 for transmitting data to a magnetic head 104 of a disk drive is shown in FIG. 1. The circuit 100 is used as an example of a circuit for cancelling reflected waves. The reflection cancellation circuits described in the circuit 100 may be implemented in other circuits by those skilled in the art. The circuit 100 includes two current sources, a first current source 110 and a second current source 112 that act as a differential driver. For example, the first current source 110, may supply current while the second current source 112 sinks current. The current generates a magnetic field in the head 104 that is used to magnetize a magnetic disk.

The first current source 110 is connected to a first node N1. The first node N1 is connected to a first transmission line 116, which in turn is connected to the head 104. It is noted that the transmission line 116 may be any conductor that conducts current to the head 104. Due to the high speed of data transmission, the conductor will act like a transmission line in that some of the current will be reflected back to the first current source 110 due to impedance mismatching. In other embodiments, the transmission line 116 may be a conventional transmission line, but it may not be matched to other components in the circuit 100, including the head 104. This mismatch too may cause reflections back to the first current source 110.

The second current source 112 is connected to a second node N2 that is connected to a second transmission line 118. The second transmission line 118 may be substantially similar or identical to the first transmission line 116 and is connected to the head 104. The circuits associated with the second current source 112 are subject to the same reflection problems as the circuits associated with the first current source 110. it is noted that the impedance, Z_{L}, in the head 104 may be much less than the impedance, Z_{O}, of the transmission lines 118, 118, which makes the reflection coefficient less than zero and causes reflections.

The circuit 100 operates by causing current to flow in either direction through the head 104. In a first operative mode, the first current source 110 sources current and the second current source 112 sinks current, so the current flows in a first direction through the head 104. In a second operative mode, the second current source 112 sources current and the first current source 110 sinks current. In this second operative mode, the current flows through the head in a second direction. It can be seen that the first and second operative modes can be used to magnetize the disk media in different polarities. In both operative modes, reflection back to the current sources 110, 112 will occur if impedances are not matched correctly. The circuit 100 uses channel length modulation of the transistors in the circuit 100 to cancel the reflections as described below.

The circuit 100 has a plurality of transistors connected to each node N1, N2. The transistors are connected so that they may cancel reflected current when the current sources 110, 112 are operating in both the first mode and the second mode. Two transistors, Q1 and Q2, are connected in series between a power source and the first node N1. Two transistors, Q3 and Q4, are connected in series between the first node N1 and ground. The transistors Q1-Q4 are sometimes referred to as being connected in series. The transistor Q2 provides cascode biasing for the transistor Q1 and the transistor Q3 provides cascode biasing for the transistors Q4. With respect to the second current source 112, two transistors, Q5 and Q6 are connected between the power source and the second node N2. Two transistors, Q7 and Q8, are connected between the second node N2 and ground. The transistors Q5-Q8 are sometimes referred to as being connected in series. The transistor Q6 provides cascode biasing for the transistor Q5 and the transistor Q7 provides cascode biasing for the transistor Q8.

The transistors described above use complimentary metal oxide semiconductor (CMOS) devices. Conventionally, CMOS devices have not been used in such applications because of the high capacitance associated with the CMOS devices. For example, CMOS transistors may have high channel length modulation. The high capacitance of CMOS devices makes impedance matching very difficult at high frequencies, in some conventional applications, circuits have to be tuned in order to achieve acceptable impedance matching. The CMOS devices do offer advantages, such as lower cost, lower power consumption, lower number of masks for fabrication, lower fabrication time, etc., over other devices. The circuit 100, using the transistors described above, enables the use of CMOS devices by cancelling reflected waves caused by impedance mismatches.

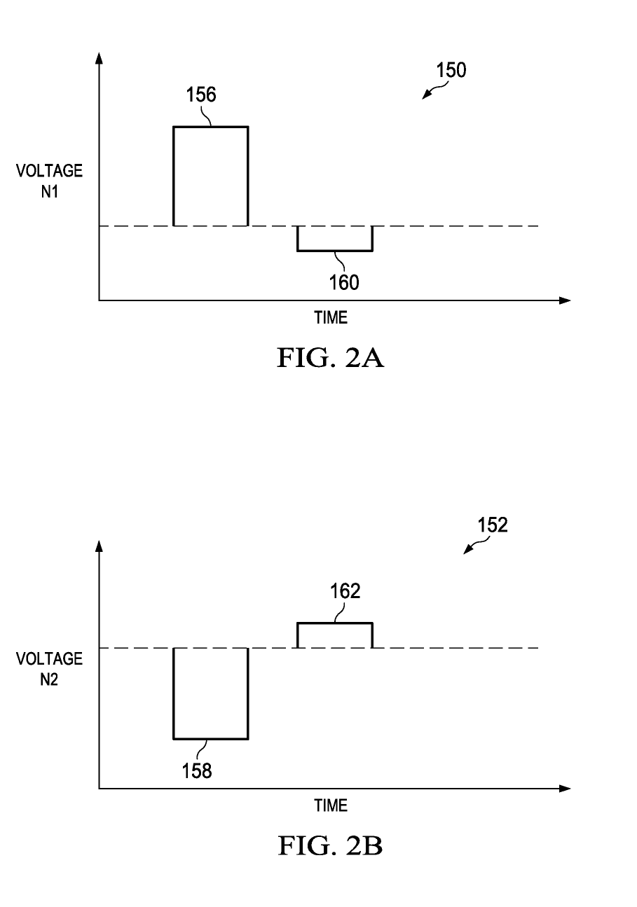

Having described the circuit 100, is operation will now be described. The circuit 100 uses two current sources 110, 112 to create a magnetic field on the head 104, which magnetizes a magnetic disk. The current sources 110, 112 are referred to as current sources in that current is used to create the magnetic field in the head 104. In doing so, the current sources 110, 112 generate voltage pulses or signals that are described herein for ease of the description. Reference is made to FIGS. 2A and 2B, which show graphs 150, 152 of the signals generated in the circuit 100 in the first operative mode.

Heads write data at very fast rates, so the signals from the current sources 110, 112 are high frequency. The head 104 may not be matched to components within the circuit 100, so the head 104 will likely cause some reflections, which are referred to as reflected waves. The reflected waves are numbered in some instances herein. The numbering of the reflected waves is used solely for reference purposes and does not indicate the order in which reflection occurs.

FIG. 2A shows voltages present at the first node N1 during the first operative mode and FIG. 2B shows voltages present at the second node N2 during the first operative mode. An opposite, second operative mode is described below A pulse 156 is the signal generated by the first current source 110. A pulse 158 is the signal generated by the second current source 112. It is noted that the signals 156, 158 have opposite polarity in order to drive current from the first current source 110, through the head 104 and to the second current source 112.

After a time, which is approximately equal to twice the propagation delay of the transmission line 116 after the signal 156 is transmitted by the first current source 110, a reflected wave 160 arrives at the first node N1. Likewise, a short time after the signal 158 is transmitted by the second current source 112, a reflected wave 162 arrives at the second node N2. The reflected wave 160 has the opposite polarity of the signal 156 transmitted by the first current source 110 and pulls the potential of the first node N1 more negative. The change in potential on the first node N1 causes the drain to source voltage V_{DS} of the transistor Q1 to increase, which instantaneously causes the drain current to increase due to channel length modulation and cancel the reflected wave 160.

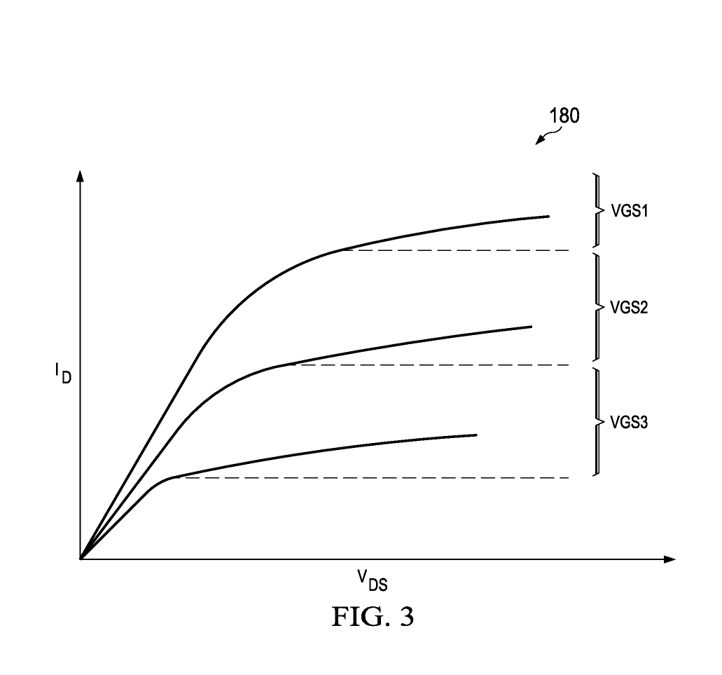

Reference is made to the graph 180 of FIG. 3, which shows the operating characteristics of the transistors described above. More specifically, the graph 180 shows the relationship between the drain to source voltage, V_{DS}, and the drain current I_{D}. The relationship between I_{D} and V_{DS} is governed by the gate to source voltage VGS. The graph 180 has three different V_{GS} values, which are noted as V_{GS1}, V_{GS2}, and V_{GS3}. The value of V_{GS1} is greater than V_{GS3}, which results in a greater drain current for the same drain to source voltage. Accordingly, a higher gate to source voltage V_{GS} will result in a higher drain current I_{D}.

Ideal transistors saturate, meaning that their drain currents have a maximum value even as the drain to source voltage increases. The ideal transistor characteristics are shown by the dashed lines of the graph 180. The transistors of FIG. 1 are operated in the saturation mode or an early saturation mode where the drain to source voltage V_{DS} is low, but the transistor is operating in the saturation mode. The transistors used in the circuit of FIG. 1 undergo channel length modulation with increasing drain to source voltage as shown by the solid lines of FIG. 3. More specifically, the channel length modulation causes the drain current to continuously increase, even when the transistor is in the saturation mode. In most applications, channel length modulation adversely affects the transistors and associated circuits; however, channel length modulation is used herein to cancel the reflected waves 160, 162.

The first current source 110 transmits a first signal 156, FIG. 2A, to the head 104 while the second current source 112 simultaneously transmits a second signal 158 to the head 104. The first and second signals 156, 158 may be the same magnitude with opposite polarities to cause current flow through the head 104. The impedance mismatch with the head 104 causes two reflected waves in the circuit 100. The first reflected wave 160 travels to the first current source 110 and the second reflected wave 162 travels to the second current source 112. The first wave 160 and the second wave 162 may have approximately the same magnitude, but they may have opposite polarities.

The first reflected wave 160 has the opposite polarity as the first signal 156. When the first reflected wave 160 propagates to the first node N1, the first reflected wave 160 shifts the potential of the first node N1 down. The downward shift in potential increases the drain to source voltage V_{DS} of the transistor Q1. Referring to FIG. 3, the increase voltage V_{DS} on the transistor Q1 instantaneously increases the drain current I_{D} due to the channel length modulation in the transistor Q1, which cancels the first reflected wave 160. The second reflected wave 162 propagates to the second node N2, where it increases the potential at the second node N2. The increased potential increases the drain to source voltage V_{DS} of the transistor Q8, which instantaneously increases the drain current I_{D} through the transistor Q8 and cancels the second reflected wave 162.

The first and second reflected waves 160, 162 have been cancelled by the channel length modulation in the transistors Q1 and Q8. The channel length modulation will cancel the reflected waves during the time that they are present at their respective nodes N1, N2. In addition to channel length modulation, the drain current I_{D} may increase by way of an increase in the gate to source voltage V_{GS} of the transistors Q1 and Q8. Capacitive coupling in the transistors Q1 and Q8 will cause the gate to source voltage V_{GS} to increase instantaneously when the reflected waves 160, 162 propagate to the nodes N1 and N2. As shown in FIG. 3, the increased gate to source voltage V_{GS} will cause an instantaneous increase in drain current I_{D}. Due to the capacitive coupling, the gate to source voltage V_{GS} will return to a voltage in which it is biased, so the increased drain current I_{D} may be shorter than the period of the reflected wave.

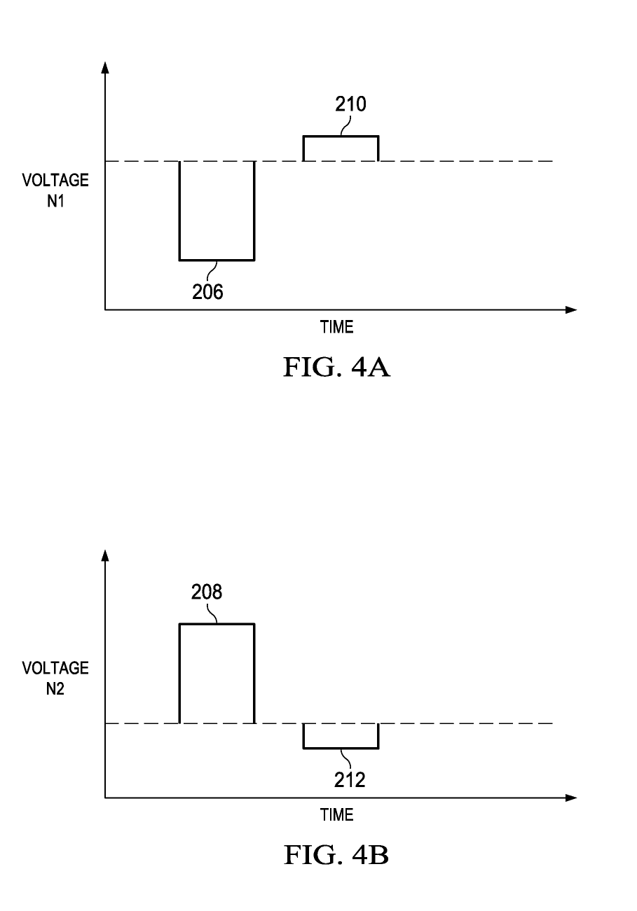

The example described above is used when the current flows from the first current source 110, through the head 104, and to the second current source 112. In the following example, the current flows in the opposite direction, which is used to charge the magnetic media with the opposite polarity. Reference is made to FIGS. 4A and 4B, which show the signals and reflected waves in the following example. The operation of the circuit as described below is a second operative mode in that the head 104 charges the magnetic media in the opposite polarity as the first operative mode.

The first current source 110 transmits a signal 206, FIG. 4A, to the head 104 while the second current source 112 simultaneously transmits a signal 208, FIG. 4B, to the head 104. The signal 206 is sometimes referred to as the third signal and the signal 20$ is sometimes referred to as the fourth signal. The signals 206, 208 may be the same magnitude with opposite polarities to cause current flow through the head 104 in the direction from the second current source 112 to the first current source 110. The mismatched impedance with the head 104 causes two reflected waves in the circuit 100. A reflected wave 210 travels to the first current source 110 and a reflected wave 212 travels to the second current source 112. The waves 210, 212 may have approximately the same magnitude, but they may have opposite polarities. The wave 210 is sometimes referred to as the third reflected wave and the wave 212 is sometimes referred to as the fourth reflected wave.

The reflected wave 210 has the opposite polarity as the signal 206. When the reflected wave 210 propagates to the first node N1, the reflected wave 210 shifts the potential of the first node N1 up. The upward shift in potential increases the drain to source voltage V_{DS} of the transistor Q4. Referring to FIG. 3, the increased voltage V_{DS} on the transistor Q4 instantaneously increases the drain current I_{D} due to the channel length modulation, which cancels the reflected wave 210 as described above. The reflected wave 212 propagates to the second node N2, where it decreases the potential at the second node N2. The decreased potential increases the drain to source voltage V_{DS}, of the transistor Q5, which instantaneously increases the drain current I_{D} through the transistor Q5 and cancels the reflected wave 212.

Based on the foregoing, the circuit 100 will cancel all reflected waves regardless of whether the circuit 100 is operated in the first mode or the second mode. It is noted that the circuit 100 may be modified so that it only uses one of the two current sources 110, 112. It is also noted that the circuit 100 may be modified so that only a single transistor and its biasing transistor are connected to a node N1, N2. In such embodiments, only reflected waves of a specific polarity would be cancelled.

The foregoing description of specific embodiments reflected wave cancellation has been presented for purposes of illustration and description. The specific embodiments described are not intended to be exhaustive or to suggest a constraint to the precise forms disclosed, and many modifications and variations are possible in light of the above teaching, The illustrated embodiments were chosen and described in order to best explain principles and practical application, to thereby enable others skilled in the art to best utilize the various embodiments with various modifications as are suited to the particular use contemplated, it is intended that the language of the claims appended hereto be broadly construed so as to cover different embodiments of the structures and methods expressly disclosed here, except as limited by the prior art.

What is claimed is:

1. A method for cancelling reflected waves from a load, the method comprising:
transmitting a first signal to the load from a first current source, wherein a first transistor is connected in parallel with the first current source at a first node;
biasing the first transistor so that a first reflected wave at the first node will increase the drain to source voltage of the first transistor; and
increasing the drain current of the first transistor by way of channel length modulation when the drain to source voltage increases, the increased drain current cancelling the first reflected wave.

2. The method of claim 1, wherein the increasing further comprises increasing the gate voltage of the first transistor by way of internal capacitance in the first transistor.

3. The method of claim 1, wherein the increasing further comprises increasing the gate voltage of the first transistor by way of internal gate to drain capacitance within the first transistor.

4. The method of claim 1 wherein the biasing comprises cascode biasing the first transistor.

5. The method of claim 1 wherein a second transistor is connected to the first node and in series with the first transistor, the method further comprising:
biasing the second transistor so that a second reflected wave at the first node will cause an increase in the drain to source voltage of the second transistor, the second reflected wave having the opposite polarity of the first reflected wave; and
increasing the drain current of the second transistor by way of channel length modulation when the drain to source voltage increases, the increased drain current cancelling the second reflected wave.

6. The method of claim 5, wherein the increasing the drain current of the second transistor further comprises increasing the gate voltage of the second transistor by way of internal gate to drain capacitance within the second transistor.

7. The method of claim 5 wherein the biasing the second transistor comprises cascode biasing the second transistor.

8. The method of claim 1 and further comprising:
transmitting a second signal to the load from a second current source, wherein a third transistor is connected in parallel with the second current source at a second node;
biasing the third transistor so that a third reflected wave at the second node will increase the drain to source voltage of the third transistor; and
increasing the drain current of the third transistor by way of channel length modulation when the drain to source voltage increases, the increased drain current cancelling the third reflected wave.

9. The method of claim 8, wherein the first signal and the second signal are transmitted simultaneously and wherein the first signal has the opposite polarity of the second signal.

10. The method of claim 8, wherein the increasing further comprises increasing the gate voltage of the third transistor by way of internal capacitance in the third transistor.

11. The method of claim 8, wherein the increasing further comprises increasing the gate voltage of the third transistor by way of internal gate to drain capacitance within the third transistor.

12. The method of claim 8 wherein the biasing comprises cascade biasing the third transistor.

13. The method of claim 8 wherein a fourth transistor is connected to the second node and in series with the third transistor, the method further comprising:
biasing the fourth transistor so that a fourth reflected wave at the second node will increase the drain to source voltage of the fourth transistor, the fourth reflected wave having the opposite polarity of the third reflected wave; and
increasing the drain current of the fourth transistor by way of channel length modulation When the drain to source Voltage increases, the increased drain current cancelling the fourth reflected wave.

14. A circuit for cancelling a reflected wave, the circuit comprising:
a first current source connected to a first node; and
a first transistor connected to the first node and in parallel with the first current source, the first transistor being biased so that when a first reflected wave is present at the first node, the drain to source voltage of the first transistor increases;
wherein the increased drain to source voltage increases the drain current through the first transistor by way of channel length modulation and cancels the first reflected wave.

15. The circuit of claim 14, wherein the first current source drives a head that magnetizes a magnetic disk.

16. The circuit of claim 14 and further comprising a second transistor connected to the first node, the second transistor being connected in series with the first transistor, the second transistor being biased so that when a second reflected wave is present at the first node, the drain to source voltage of the second transistor increases; and wherein the increased drain to source voltage increases the drain current through the second transistor by way of channel length modulation and cancels the second reflected wove.

17. The circuit of claim 16, wherein the first transistor and the second transistor are cascode biased.

18. The circuit of claim 16 and further comprising:
a second current source connected to a second node; and
a third transistor connected to the second node and in parallel with the second current source, the third transistor being biased so that when a third reflected wave is present at the second node, the drain to source voltage of the third transistor increases;
wherein the increased drain to source voltage increases the drain current through the third transistor by way of channel length modulation and cancels the third reflected wave.

19. The circuit of claim 18 and further comprising a fourth transistor connected to the second node, the fourth transistor being connected in series with the third transistor, the fourth transistor being biased so that when a fourth reflected wave is present at the second node, the drain to source voltage of the fourth transistor increases; and wherein the increased drain to source voltage increases the drain current through the fourth transistor by way of channel length modulation and cancels the fourth reflected wave.

20. A method for cancelling reflected waves from the head of a disk drive, the method comprising:
transmitting a first signal to the head from a first current source, wherein a first transistor and a second transistor are connected in series with each other and each of the first and second transistors are connected in parallel with the first current source at a first node;
transmitting a second signal to the head from a second current source, wherein a third transistor and a fourth transistor are connected in series with each other and each of the third transistor and fourth transistor are connected in parallel with the second current source at a second node, wherein the first and second signals are transmitted simultaneously and have opposite polarities;
biasing the first and second transistors so that a first reflected wave at the first node increase the drain to source voltage of the first transistor or the second transistor;
increasing the drain current of the first transistor or second transistor by way of channel length modulation when the drain to source voltage increases, the increased drain current cancelling the first reflected wave;
biasing the third and fourth transistors so that a second reflected wave at the second node increases the drain to source voltage of the third transistor or the fourth transistor;
increasing the drain current of the third transistor or fourth transistor by way of channel length modulation when the drain to source voltage increases, the increased drain current cancelling the second reflected wave.
